(19) United States
(12) Patent Application Publication
(10) Pub. No.: US 2025/0392918 A1
(43) Pub. Date: Dec. 25, 2025

(54) NOTIFYING USERS OF REQUESTS FOR SECRET IDENTIFIERS

(71) Applicant: GOOGLE LLC, Mountain View, CA (US)

(72) Inventors: Gil Cukierman, Jersey City, NJ (US); Roger Piqueras Jover, New York, NY (US); Yomna Nasser, San Francisco, CA (US)

(21) Appl. No.: 18/750,273

(22) Filed: Jun. 21, 2024

(51) Int. Cl. H04W 12/69; H04W 4/12

(52) U.S. Cl. CPC H04W 12/69; H04W 4/12

(57) ABSTRACT

A user equipment includes a transceiver configured to transmit and receive signals over an air interface, a memory configured to store executable instructions, and a processor configured to execute instructions stored on the memory. The instructions allow the user equipment to detect reception of a request to transmit a secret identifier of the user equipment over the air interface and provide a notification to a user of the user equipment in response to detecting the reception of the request.

### BACKGROUND

The subscriber identity module (SIM) card in a mobile device is uniquely identified by an International Mobile Subscriber Identity (IMSI) or, in the case of 5G-SA (Fifth-Generation Standalone Mode), the Subscription Permanent Identifier (SUPI). An International Mobile Equipment Identity (IMEI) number is a 15-digit unique number assigned to mobile phones and smartphones that run on the Global System for Mobile communication (GSM) network. These unique identifiers typically are kept secret because they can be used to track mobile devices and open the door to other exploits. To protect the secrecy of the IMSI or other identifiers, a Temporary Mobile Subscriber Identifier (TMSI) is derived when the mobile device connects to the network for the first time. Similarly, the GUTI (Globally Unique Temporary Identifier) and the 5G-GUTI are derived when the mobile device connects to a 4G or 5G network. In the interest of clarity, the term “secret identifier” will be used to indicate an IMSI, SUPI, IMEI, or any other identifier that permanently identifies the SIM card and/or the mobile device. The term “temporary identifier” will be used herein to indicate a TMSI, GUTI, 5G-GUTI, or any other identifier that temporarily identifies the SIM card in the mobile device during communication over the air interface.

Once an initial network connection is established between the SIM card and the network, the mobile device is uniquely addressed using a rotation of temporary identifiers. There are, however, several circumstances in which a mobile device transmits its secret identifier in the clear such as: (1) prior to the network deriving a temporary identifier for the mobile device or (2) in the rare event that the temporary identifier has been lost. These circumstances present opportunities for third parties to capture the secret identifier. For example, if a mobile device attempts to connect to a base station by transmitting a request including its temporary identifier, the base station can respond with a message indicating that the base station does not recognize the temporary identifier and requires the mobile device's secret identifier. Conventional mobile devices respond to this message with a new request that includes the secret identifier, thereby revealing the secret identifier to the owner of the base station. Other messages may also be used to request the secret identifier of a mobile device.

Base stations can therefore be configured to trick mobile devices into revealing their secret identifiers. These base stations are sometimes known as cell site simulators, IMSI catchers, false base stations, rogue base stations, and the like. In the interest of clarity, base stations that attempt to capture secret identifiers are collectively referred to herein as false base stations. False base stations have been used to track user locations outside of legal cooperation with carriers, e.g., for warrantless or dragnet surveillance. The cost of implementing a false base station and the technical expertise needed to operate one have dropped significantly. Thus, the threat to users is increasing because the number of people and organizations capable of implementing false base stations is increasing. Currently, users of mobile devices have no way to know whether their secret identifiers are being revealed. Consequently, users cannot assess the risk presented by false base stations.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a wireless communication system in accordance with some embodiments.

FIGS. 2-4 illustrate message exchanges between user equipment and a false base station, according to some embodiments.

FIG. 5 illustrates a message exchange between user equipment, a base station, and a false base station, according to some embodiments.

FIG. 6 illustrates a method of notifying users that a secret identifier is being transmitted in the clear, according to some embodiments.

### DETAILED DESCRIPTION

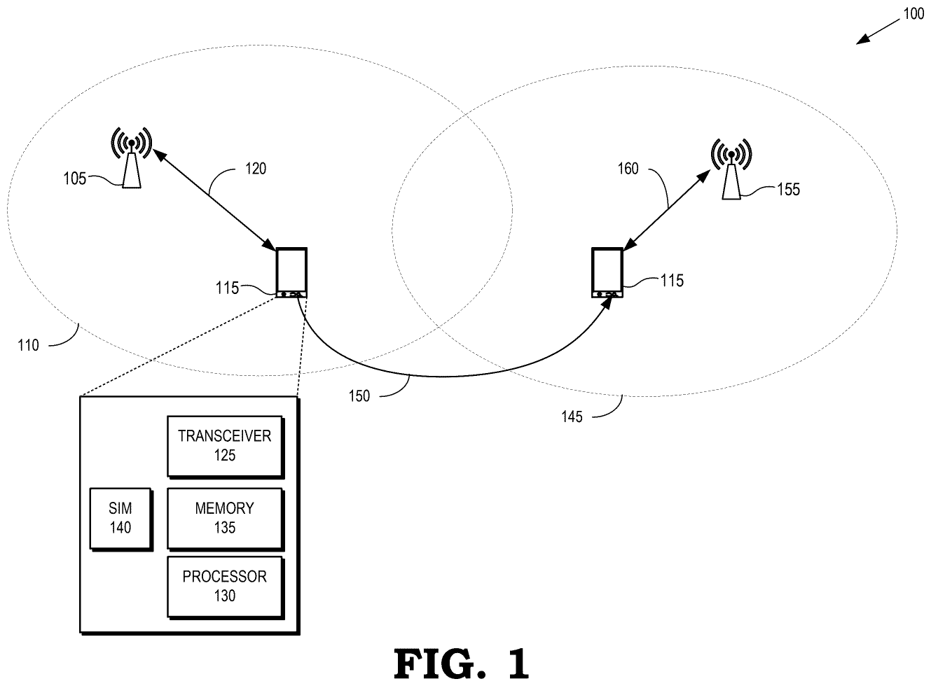

FIGS. 1-6 describe systems and techniques for enhancing the privacy and security of mobile device users by notifying the user in response to the mobile device receiving a request to transmit its secret identifier. The user notification can be generated in real-time as a standalone notification on the mobile device screen, via a safety center, or as part of an aggregate report indicating how often the secret identifier has been sent in the clear during a predetermined time interval. In some cases, the user notification includes (or is associated with) information indicating a network configuration that provides enhanced security to reduce the likelihood that the secret identifier is used to compromise the privacy and security of the mobile device. For example, the user notification can include a recommendation to enable the encryption of the IMSI with a public key associated with the network or to limit the connectivity of the mobile device to 5G-SA base stations, which support encryption of the secret identifier (SUPI). For another example, the user notification could provide an option to abort connection attempts if a given connection attempt requires transmitting the secret identifier in the clear.

FIG. 1 illustrates wireless communication system 100, according to some embodiments. The wireless communication system 100 includes one or more base stations 105 that provide wireless connectivity within a geographic area or cell 110. User equipment 115 is located within cell 110 and can establish a connection over the air interface 120 to the base station 105. The connection can be established according to protocols such as the Third Generation (3G), Fourth Generation (4G), or Fifth Generation (5G) protocols defined by the Third Generation Partnership Project (3GPP). User equipment 115 includes a transceiver 125 for transmitting and receiving signals over the air interface 120, a processor 130 for executing instructions that perform operations on data and generate results, and a memory 135 that stores information representing the instructions executed by the processor 130, data provided to the processor 130, and results generated by the processor 130. The user equipment 115 also includes a SIM card 140 that stores information including a secret identifier that uniquely identifies the SIM card 140 and the associated user equipment 115.

User equipment 115 can transmit the secret identifier in the clear (e.g., as an unencrypted, plaintext representation of the secret identifier) during an initial attach procedure to the network in the wireless communication system 100. For example, user equipment 115 can transmit the secret identifier in the clear to the base station 105 when user equipment 115 initially attaches to the network. Once an initial network connection is established between the SIM card 140 and the network, user equipment 115 is uniquely addressed in the network using a rotation of temporary identifiers that are generated by the base station 105 or other entities within the wireless communication system 100. For example, if user equipment 115 moves from the cell 110 to the cell 145, as indicated by the arrow 150, user equipment 115 can establish a connection with base station 155 in the cell 145 over the air interface 160 using a previously generated temporary identifier or a new temporary identifier. Temporary identifiers can be generated randomly or using other algorithms that produce values that are not derived from the previous temporary identifier.

However, in the illustrated embodiment, base station 155 is a false base station 155 that has been configured to trick the user equipment into transmitting its secret identifier over the air interface 160 in the clear. In response to the user equipment 115 sending a request to attach to the false base station 155, the false base station 155 responds with a message indicating that the false base station 155 does not recognize the temporary identifier and requires the secret identifier of user equipment 115. User equipment 115 detects reception of the request to transmit its secret identifier over the air interface 160. Recognizing that this request may indicate a privacy violation or security threat, user equipment 115 provides a notification to the user in response to detecting the reception of the request. The user may therefore take actions to mitigate the privacy violation or security threat, as discussed herein.

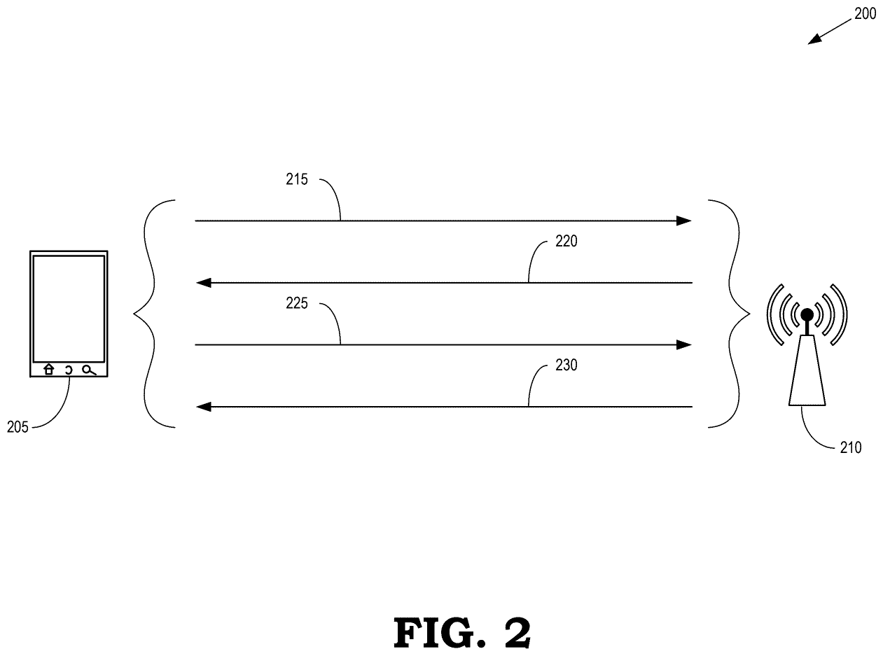

FIG. 2 illustrates a message exchange 200 between user equipment 205 and a false base station 210, according to some embodiments. The message exchange 200 is implemented in some embodiments of the user equipment 115 and the false base station 155 shown in FIG. 1.

Message 215 is transmitted from user equipment 205 over the air interface to the false base station 210. The message 215 includes information indicating that user equipment 205 is requesting a connection with the false base station 210. The message 215 also includes information indicating a temporary identifier of user equipment 205.

In response to receiving message 215, the false base station 210 transmits message 220 over the air interface to user equipment 205. The message 220 includes information indicating that the false base station 210 does not recognize the temporary identifier. The message 220 also includes a request for the secret identifier of user equipment 205.

In response to receiving message 220, user equipment 205 transmits message 225 including a new connection request. The user equipment 205 does not recognize the message 220 as a potential privacy violation or security threat and so the message 225 also includes the secret identifier requested by the false base station 210.

In response to receiving message 225, the false base station 210 transmits message 230 including an acknowledgment that it has received the message 225. Now that the false base station 210 knows the secret identifier of user equipment 205, the false base station 210 can track the user equipment 205 without user consent, as well as potentially performing other unauthorized actions.

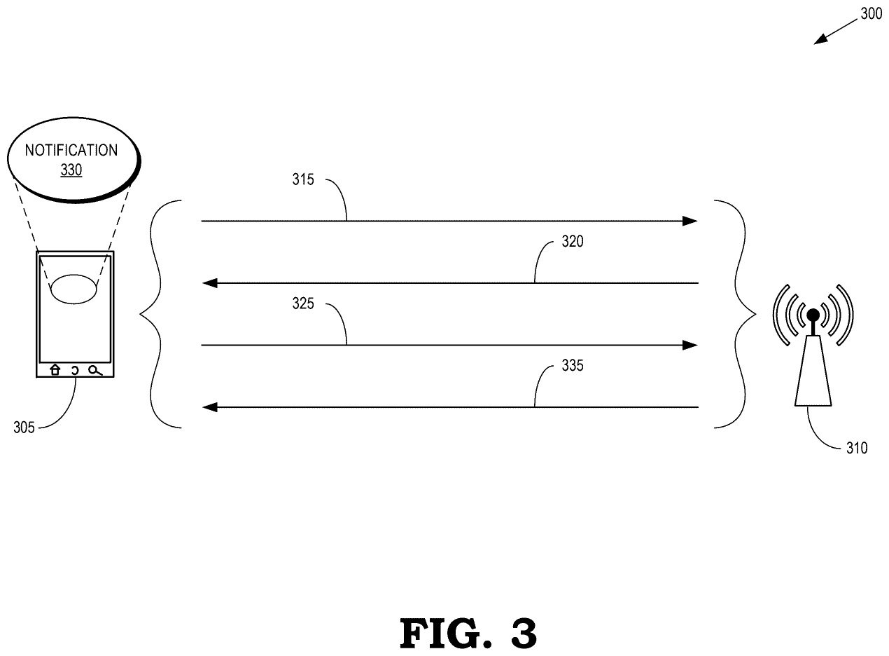

FIG. 3 illustrates a message exchange 300 between user equipment 305 and a false base station 310, according to some embodiments. The message exchange 300 is implemented in some embodiments of user equipment 115 and the false base station 155 shown in FIG. 1.

Message 315 is transmitted from user equipment 305 over the air interface to the false base station 310. The message 315 includes information indicating that user equipment 305 requests a connection with the false base station 310. The message 315 also includes information indicating a temporary identifier of the user equipment 305.

In response to receiving message 315, the false base station 310 transmits message 320 over the air interface to user equipment 305. The message 320 includes information indicating that the false base station 310 does not recognize the temporary identifier. The message 320 also includes a request for the secret identifier of user equipment 305.

In response to receiving message 320, user equipment 305 transmits message 325 including a new connection request. The message 325 also includes the secret identifier requested by the false base station 310. However, in the illustrated embodiment, the user equipment 305 recognizes the message 320 as a potential privacy violation or security threat. User equipment 305 generates a notification 330 and provides notification 330 to the user on the display of the user equipment 305. In one embodiment, the notification 330 is generated using a hardware abstraction layer API for unsolicited events from a cellular modem or transceiver in the user equipment 305. An operating system of user equipment 305 is notified in real time in response to a secret identifier being sent in the clear (e.g., unenciphered or unencrypted) in a pre-authenticated message on the nonaccess stratum (NAS).

In response to receiving message 325, the false base station 310 transmits message 335 including an acknowledgment that it has received the message 325. Now that the false base station 310 knows the secret identifier of user equipment 305, the false base station 310 can track the user equipment 305 without user consent, as well as potentially performing other unauthorized actions. However, the notification 330 alerts the user to the potential threat and allows the user to take actions that mitigate the threat. The notification 330 can be generated in real-time as a standalone notification on the mobile device screen, via a safety center, or as part of an aggregate report indicating how often the secret identifier has been sent in the clear during a predetermined time interval. In some cases, the notification 330 includes (or is associated with) information indicating a network configuration that provides enhanced security to reduce the likelihood that the secret identifier is used to compromise the privacy and security of user equipment 305. For example, the notification 330 can include a recommendation to enable the encryption of the secret identifier with a public key associated with the network or to limit the connectivity of the user equipment 305 to 5G base stations, which support encryption of the secret identifier. For another example, the notification 330 can provide an option to abort a connection attempt before it occurs if the connection attempt requires transmitting the secret identifier in the clear.

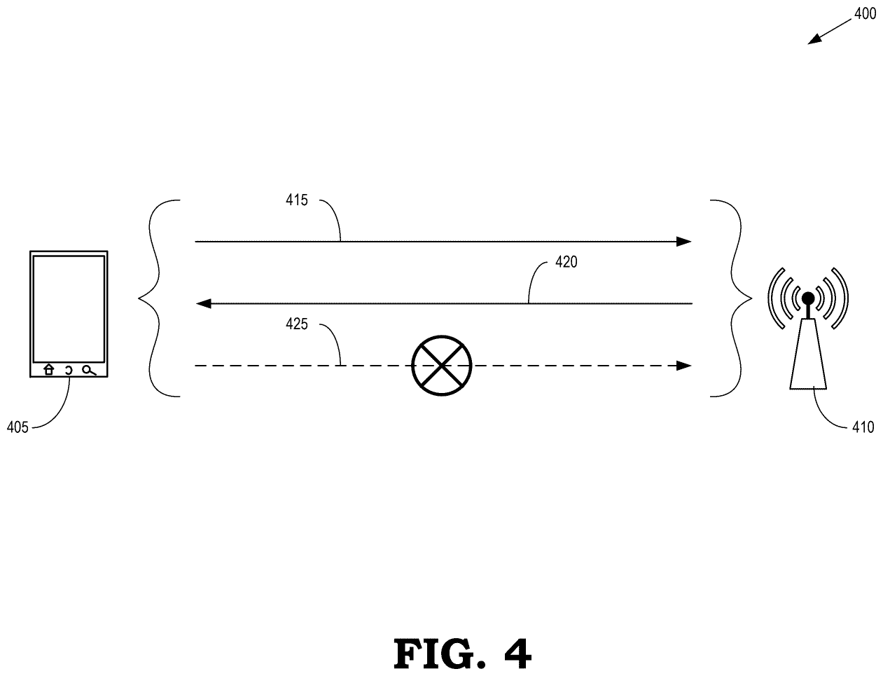

FIG. 4 illustrates a message exchange 400 between user equipment 405 and a false base station 410, according to some embodiments. The message exchange 400 is implemented in some embodiments of user equipment 115 and the false base station 155 shown in FIG. 1.

Message 415 is transmitted from user equipment 405 over the air interface to the false base station 410. The message 415 includes information indicating that user equipment 405 requests a connection with the false base station 410. The message 415 also includes information indicating a temporary identifier of the user equipment 405.

In response to receiving message 415, the false base station 410 transmits message 420 over the air interface to user equipment 405. The message 420 includes information indicating that the false base station 410 does not recognize the temporary identifier. The message 420 also includes a request for the secret identifier of user equipment 405.

In response to receiving message 420, user equipment 405 recognizes that the request for transmission of the secret identifier in the clear is a potential privacy violation or security threat. The user equipment 405 therefore aborts the connection attempt, e.g., by discontinuing the transmission of any further messages or by transmitting a disconnect message 425 to the false base station 410.

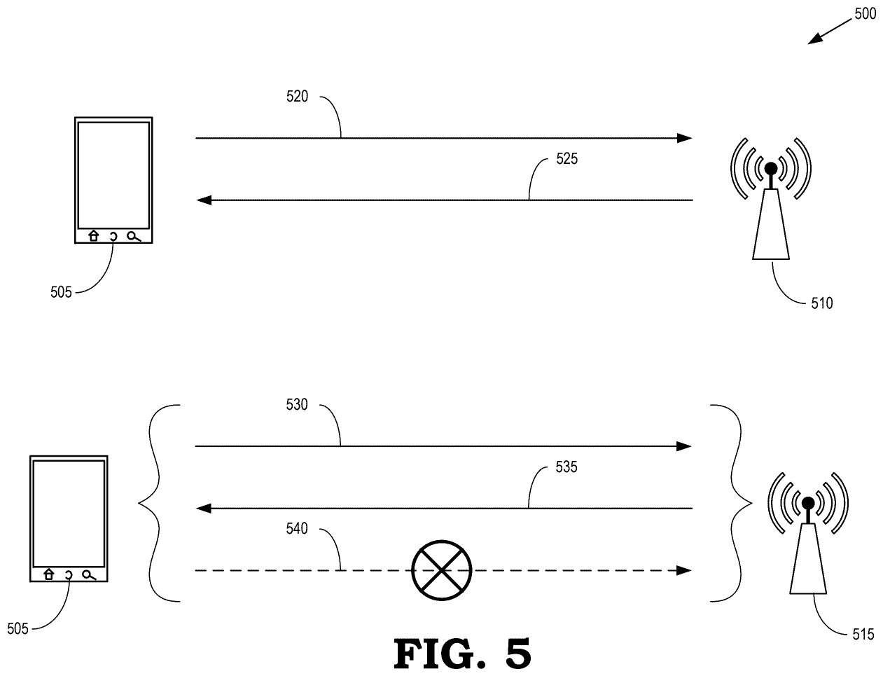

FIG. 5 illustrates a message exchange 400 between user equipment 505, a base station 510, and a false base station 515, according to some embodiments. The message exchange 500 is also an example of messages that can be exchanged between user equipment 115, base station 105, and the false base station 155 shown in FIG. 1.

Message 520 is transmitted from user equipment 505 over the air interface to the base station 510. The message 520 includes information indicating that user equipment 505 requests a connection with the base station 510. The message 520 also includes information indicating a first temporary identifier of the user equipment 505.

In response to receiving message 520, the base station 510 transmits a message 525 acknowledging the connection request. The message 525 also indicates that the first temporary identifier is recognized and includes a new (second) temporary identifier that the user equipment 505 should use in subsequent communication with the base station 510.

After establishing the connection with the base station 510, the user equipment 505 attempts to establish a connection with the false base station 515. In some embodiments, the user equipment 505 attempts to establish the subsequent connection in response to handing over to the false base station 515. The user equipment 505 transmits a message 530 including a connection request and the second temporary identifier. In response to receiving the message 530, the false base station 515 transmits message 535 over the air interface to user equipment 505. The message 535 includes information indicating that the false base station 515 does not recognize the second temporary identifier. The message 535 also includes a request for the secret identifier of user equipment 505.

In response to receiving message 535, user equipment 505 recognizes that the request for transmission of the secret identifier in the clear is a potential privacy violation or security threat. The user equipment 505 therefore aborts the connection attempt, e.g., by discontinuing the transmission of any further messages or by transmitting a disconnect message 540 to the false base station 515.

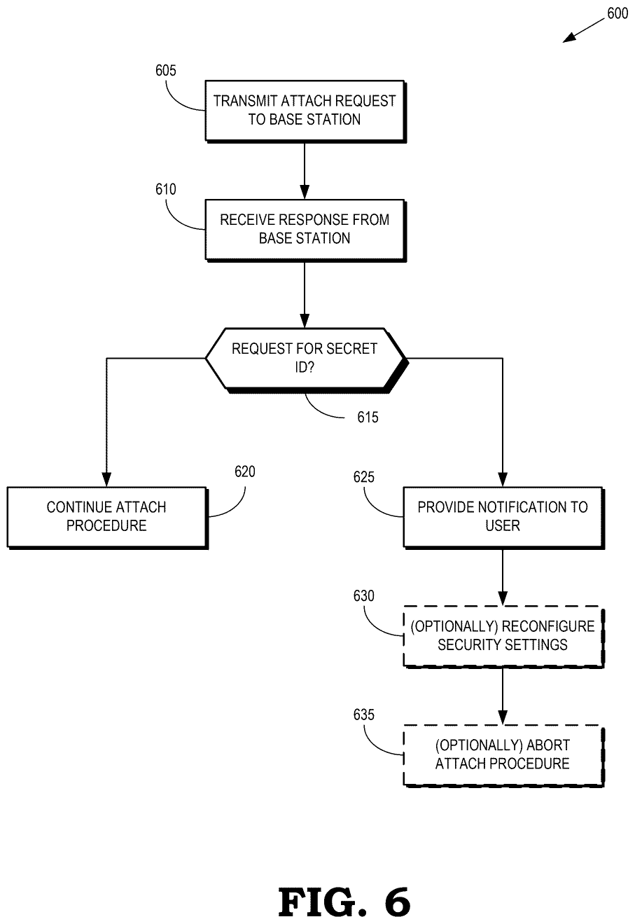

FIG. 6 illustrates a method 600 of notifying users that a secret identifier is being transmitted in the clear, according to some embodiments. The method 600 is implemented in some embodiments of the communication systems 100, 300, 400, 500 shown in FIGS. 1, 3-5.

At block 605, a user equipment transmits an attach request to a base station. The attach request includes a temporary identifier of the user equipment.

At block 610, the user equipment receives a response from the base station that acknowledges that the base station has received the attach request.

At decision block 615, the user equipment determines whether the response from the base station includes a request for a secret identifier of the user equipment. If not, the method 600 flows to the block 620. If the response includes a request for the secret identifier, which may indicate a potential privacy violation or security threat by a false base station, the method 600 flows to the block 625.

At block 620, the user equipment continues the attach procedure. For example, the user equipment can continue establishing a connection to the base station based on a temporary identifier.

At block 625, the user equipment provides a notification to the user. The notification indicates the request to transmit the secret identifier in the clear. For example, the notification can be displayed to the user as a pop-up on the screen of the user equipment.

In some embodiments, the notification includes information indicating that the user should consider reconfiguring one or security settings of the user equipment. At block 630, the user optionally reconfigures the security settings of the user equipment in response to the notification.

In some embodiments, the user equipment aborts the attach procedure in response to receiving the request to transmit the secret identifier in the clear. At block 635, the user or the user equipment optionally interrupts, stops, or aborts the attach procedure.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. User equipment comprising:
a transceiver configured to transmit and receive signals over an air interface;
a memory configured to store executable instructions;
a processor configured to execute instructions stored on the memory to:
detect reception, by the transceiver, of a request to transmit a secret identifier of the user equipment over the air interface; and
provide a notification to a user of the user equipment in response to detecting the reception of the request.

2. The user equipment of claim 1, wherein the processor is configured to provide the notification to the user in real time in response to detecting reception of the request.

3. The user equipment of claim 1, further comprising:
a display configured to present information to the user of the user equipment, wherein the processor is configured to provide the notification as a standalone notification on the display.

4. The user equipment of claim 1, wherein the processor is configured to generate an aggregate report indicating how often the secret identifier has been sent unenciphered or unencrypted during a predetermined time interval.

5. The user equipment of claim 1, wherein the notification comprises information indicating a network configuration that provides enhanced security or reduces a likelihood that the secret identifier is used to compromise the privacy or security of the user equipment.

6. The user equipment of claim 5, wherein the notification comprises a recommendation to enable encryption of the secret identifier with a public key.

7. The user equipment of claim 6, wherein the notification comprises a recommendation to limit connectivity of the user equipment to base stations that operate according to a predetermined security protocol.

8. The user equipment of claim 1, wherein the notification comprises providing the user with an option to abort connection attempts that require transmitting the secret identifier in unenciphered or unencrypted.

9. A method of operating the user equipment of claim 1.
